(19) United States
(12) Patent Application Publication
(10) Pub. No.: US 2006/0253392 A1
(43) Pub. Date: Nov. 9, 2006

(54) Payment apparatus and method

(76) Inventor: Christopher Bernard Davies, Reading (GB)

Correspondence Address: Cheryl S. Scotney;Standley Law Group, 495 Metro Place South, Suite 210, Dublin, OH, 43017-5319, US

(21) Appl. No.: 10/553,360

(22) PCT Filed: Apr. 14, 2004
(86) PCT No.: PCT/GB04/01626

§ 371 Date: Oct. 14, 2005

(30) Foreign Application Priority Data
Apr. 14, 2003 (GB) 0308629.5

(51) Int. Cl. G06Q 40/00

(52) U.S. Cl. 705/40; 705/39

(57) ABSTRACT

A secure payment system for authorised point of sale transactions enables a user to pay electronically for goods using a handheld device such as a mobile phone (115). No confidential information need be held on the handheld device (115), all financial data being held within the payment system. A short-range wireless connection is provided to the handheld device (115) and the user has only to enter a PIN to initiate a transaction. The system includes a client device (100) and a server device (110). The server device (110) maintains user profiles which enables customisation, for example of transaction receipts and payment methods. Transaction receipts can be transmitted to a preselected location, for example by email or SMS, which provides an additional security check for the user.

The present invention relates to payment apparatus and a method of payment. In one embodiment it finds application in point of sale transactions but is also useful and can be applied in other applications.

Currently when customers want to purchase goods and/or services from a store or other provider they usually pay by one of three ways, namely cash, cheque, and a card such as a debit, credit, switch or store card. These systems for payment tend to be slow and cumbersome and/or to create significant security issues. If the customer pays by cash, he/she must withdraw the cash from a bank or automatic teller machine (ATM) and carry it until purchases are made, placing the customer at risk of theft. Also merchants must carry sufficient cash float to give change on transactions. Cheques are slow to write and usually have to be supported with a card. Cards themselves are often stolen and relatively insecure, having only four digit PIN (Personal Identification Number) protection which is not used for example in the UK.

In an attempt to improve security, credit and debit cards for example are being embedded with chips in place of or in addition to the common magnetic strip currently used. When using these chip cards, all face-to-face transactions will need to be authorised by keying in a PIN. The chip system provides greater functionality and improved security against fraudulent usage. However, it has the effect of slowing down the payment process.

In a press release published in 2002, Vodafone and T-Mobile announced a payment system for the purchase of goods and services using mobile phones and an interoperable payments platform. Consumers would store financial data such as their credit card or bank account numbers on their mobile phones and press a button when ready to pay. However, such a system remains vulnerable to theft and fraud firstly because the mobile phone itself is vulnerable and secondly because the financial data has to be transmitted between phone and platform to enable payment and that is inherently vulnerable unless well-protected for example by encryption.

The opportunities in the supermarket sector in the UK currently represent some of the most compelling opportunities in retail and brand loyalty. Yet, apart from establishing a presence in personal banking, no real penetration has taken place. Further, whilst various individual types of transactions exist, up until the present there has been no technology available to integrate the various shopping propositions.

At present there is a bewildering set of transactions which can take place in a supermarket. At the entrance, cash is available from the ATM but this is supplied by a third party who is often a competing bank. Sometimes, the ATM is located in a mini-branch of that competing bank. Inside the supermarket, some supermarkets provide hand-held scanners, which enable the self-scanning of goods as the customer collects them and totals the prices to provide a form of express checkout and payment. More conventionally, scanners might be provided at the entrance. By whatever method the total is calculated, the customer might then pay using either cash or a debit, credit, switch or store card.

According to a first embodiment of the present invention, there is provided payment apparatus for use in authorised transactions, the apparatus comprising:

i) at least one client device provided with an input for communicating with one or more mobile devices; and

ii) at least one server device for providing data and/or processes to support a transaction using the at least one client device, said transaction including verification of authorisation data;

wherein the at least one client device is adapted to receive a first part of the authorisation data via its input and the apparatus is adapted to store a second part of the authorisation data.

The mobile device may have an input and an output for the first part of the authorisation data and only transient, if any, storage capability for storing said first part in the course of a transaction. Thus, the first part of the authorisation data is not stored on the mobile device for any length of time but can be entered by a user in real time for immediate transmission to the apparatus. Use of such payment apparatus means that theft and analysis of a mobile device cannot, on its own, enable a fraudulent transaction.

The apparatus may in practice store the second part of the authorisation data in any appropriate way. For example, the server device might send it to be stored in a database, local or remote, or use its own hard disc drive.

In the context of this specification, a client device and a server device are devices which each provide at least one respective software process. The client software process is adapted to make a service request to the server software process and the server software process is adapted to fulfil the request. Although both software processes could in practice be run on the same computing platform, it is usually more useful that the two software processes are run on separate computing platforms with a network connection between them. It is also usually the case that there is a plurality of client devices adapted to make service requests to a common service device, although there may be more than one server device. Peer to peer communications will usually include a client/server arrangement since each device will have both client and server software processes.

The first part of the authorisation data may comprise for example a PIN which a user enters to a mobile device for transmission to one of the one or more client devices. Alternatively, the first part of the authorisation data might comprise a PIN-specific code which the mobile device looks up on receipt of a valid PIN. The second part of the authorisation data may comprise financial data associated with that user, such as numbers for credit, debit, switch or store cards or bank accounts.

In the context of the present invention, the client device(s) might each be incorporated in, or connected to, a point of sale terminal, while the at least one server device is provided on networked computing platform elsewhere, preferably in a secure, non-public location.

Preferably, the second part of the authorisation data is not stored by a client device but is either stored by the at least one server device, or can be accessed by it, in fulfilling a service request from the client device(s). The second part of the authorisation data can thus be stored in a secure/non-public location. This can improve security since the client device is usually more vulnerable to theft or damage, particularly if physically located at a point of sale.

Preferably, the apparatus is provided with a mapping capability for mapping the first part of the authorisation data to the second part. This might be in the form of a data table, listing authorised first parts against appropriate second parts. An example would be a list of PINs, or PIN-specific code, mapped to financial data. One mobile device may be associated with more than one PIN, each being mapped directly or indirectly to a different set of financial data. Preferably, the mapping capability is provided by the at least one server device, and not a client device, for increased system security.

The server device may itself be associated with a further client device so that it can fulfil a service request by initiating a further service request to another server device. This arrangement will be appropriate for example where a service request requires checks to be made with other systems such as credit checks with credit card or banking systems. Alternatively, the server device might have an associated data connection or remote query facility for querying other systems or databases.

Conveniently, the one or more mobile devices might comprise handheld communication devices such as mobile telephones or personal digital assistants.

Preferably, the connection for communicating with one or more mobile devices is wireless since this is generally more convenient for users. More preferably, the connection is a data connection, which is established without the user having to dial up since this takes time and would slow down a transaction. Preferably the data connection is short-range to avoid hacking or eavesdropping, such as an infrared (IR) connection with a range of 0.5 metres or less.

Preferably, the mobile device itself has a unique identifier, such as a telephone number, associated with it. To provide improved security, the apparatus may be provided with validation means for validating the unique identifier prior to completing a transaction. For example, the client and/or server devices may be adapted to be triggered during a transaction, for example on receipt of the first part of the authorisation data, to request the unique identifier from the mobile device and to review it against validation data. In one arrangement, the client device might request the unique identifier and forward it to the server device which in turn forwards it to an external validation location such as a network provider's database. If the mobile device has been reported stolen or damaged for example, the database may return an invalidation report and the transaction can be terminated.

In the mapping capability mentioned above, it would be possible to replace or supplement the first part of the authorisation data (for example the PIN) with the unique identifier of the mobile device for mapping against the second part of the authorisation data.

Preferably, the payment apparatus further comprises update means for updating data held on the one or more mobile devices. This can be used for example in the context of an authorised transaction to store an electronic version of cash on the mobile device. The authorised transaction might result in deduction of an amount from a user account, such as a credit card or bank account, and the recording of an amount as an available cash equivalent on the mobile device. The available cash equivalent could then be used in one or more subsequent unauthorised transactions. This supports an express payment method, which might be suitable for relatively low risk transactions, for example transactions having a low maximum value or taking place in a more generally secure environment such as an in-house system without public access.

In an arrangement, which is particularly suitable to use in a supermarket or other self-service environment, the payment apparatus may further comprise a list processor for processing a list of items covered by a transaction. The processor might compile its own list from data received sequentially, for instance via a scanner, or might receive a compiled list from for instance a point of sale terminal. The compiled list may already be priced as received from the point of sale terminal, and/or the processor may have access, in use, to current pricing and/or discounting data to enable it to calculate a cost total for use in a transaction. The processor is also preferably adapted to communicate with, or provide, a stock-keeping system to support automated updates.

The payment apparatus might usefully be provided with a user data store and a user data maintenance process for storing and updating user data in the user data store. This allows the list processor to use user specific data in processing a list of items and thus supports such things as loyalty schemes, in which a user might have a discount arising from their purchasing history.

Preferably, the payment apparatus can be connected in use to a public network. Further, the payment apparatus might incorporate a receipt generator and a receipt generated in respect of a transaction can be sent over the public network to a network address stored in the user data store. Stored user data may also or instead be used by the receipt generator in generating a receipt. For example, stored user data may indicate a preference for layout of the receipt, such as special groupings of items or tax information.

A user may wish different user data to be applied in different circumstances. This can be achieved by storing user data in association with respective identifiers for that user. As long as the payment apparatus is notified, for example by user input, as to which respective identifier applies to a transaction, it becomes possible for the payment apparatus to respond in different ways to different transactions for that user. For example, the user may wish different bank accounts to be debited for business and personal transactions, and/or receipts to be transmitted to different network addresses.

According to a second embodiment of the present invention, there is provided a receipting system for use in a purchasing transaction, the system comprising:

i) an input for receiving transaction information;

ii) an input for receiving notice of payment in respect of a transaction;

iii) a receipt generator for generating a receipt for a notified payment;

iv) a data store for storing network addresses; and

v) an interface to a network for transmitting a generated receipt to a network address, wherein each transaction has an associated identifier and the data store stores network addresses in association with transaction identifiers such that each generated receipt can be transmitted to a network address associated with the transaction giving rise to the generated receipt.

In such a receipting system, at least one identifier associated with a transaction might usefully comprise a personal identification number.

Transaction information will generally comprise content for a receipt, such as a list of goods or services against amounts paid.

The inputs for transaction information and for receiving notice of payment are not necessarily physically separate of course but receipt of information and notification will produce respective appropriate responses.

According to a third embodiment of the present invention, there is provided a payment system for use in user transactions, each transaction giving rise to a price list for goods or services covered by the transaction, wherein each user has at least one associated identifier, the payment system comprising:

i) a data store for storing user specific data in association with at least one of said identifiers; and

ii) a price list processor for processing a price list arising from a transaction, wherein the system further comprises an input for receiving identifiers and the price list processor is adapted to process a price list arising from a transaction by applying user specific data from the data store, the user specific data being associated with an identifier received in relation to said transaction.

Preferably in said payment system, at least one user has at least two associated identifiers and the data store, in use, stores different user specific data in association with each respective identifier associated with that user.

(Any individual features described herein in relation to one embodiment are generally capable of use in another embodiment of the invention and thus an embodiment of the invention might comprise any combination of features described.)

A point of sale transaction system will now be described as an embodiment of the present invention, by way of example only, with reference to the accompanying figures in which:

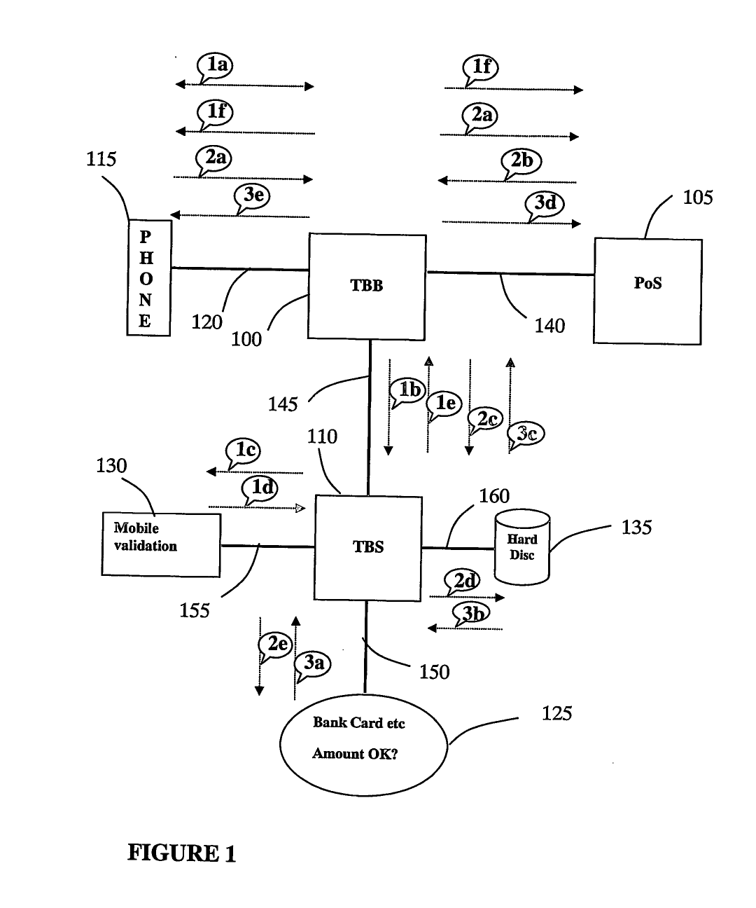

FIG. 1 shows a functional block diagram of the system and indicates schematically the data flows occurring in the system to support a transaction;

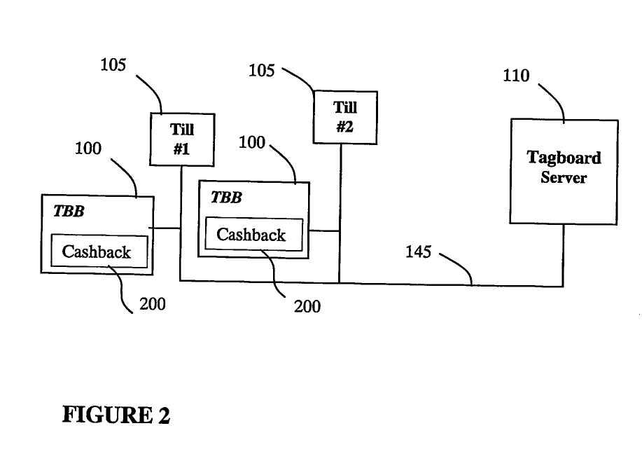

FIG. 2 shows a block diagram of multiple client devices connected to a server device for use in the transaction system;

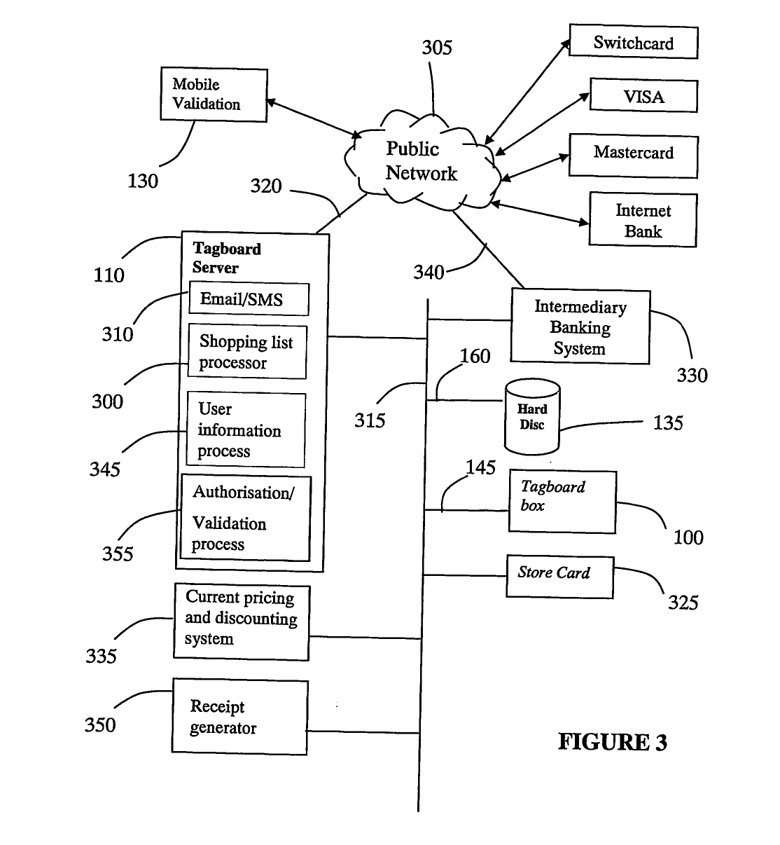

FIG. 3 shows internal and external connections for the server device as shown in FIG. 2, in use; and

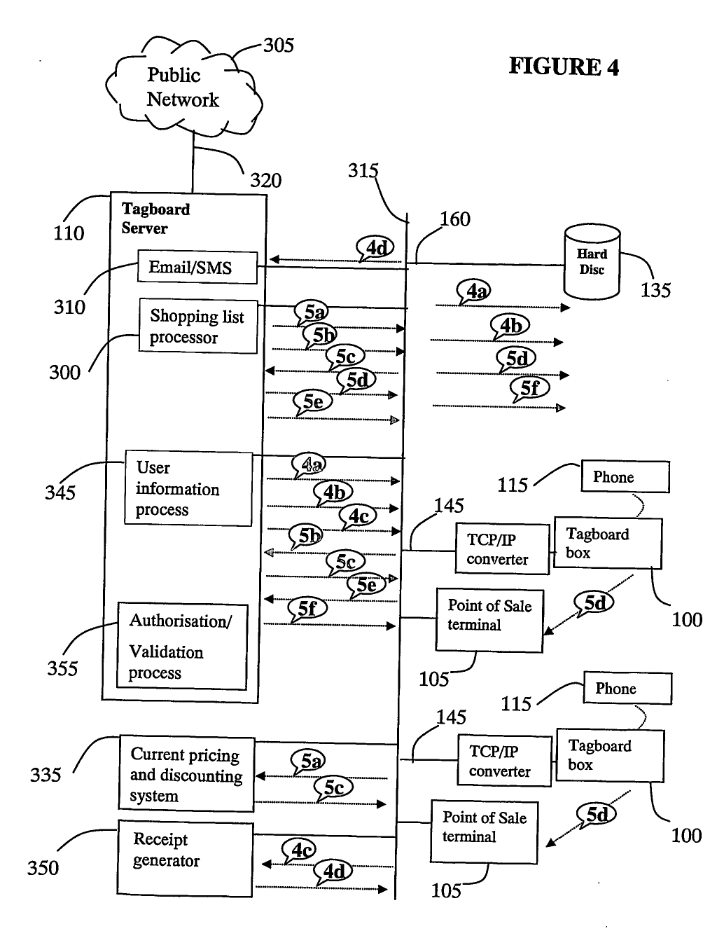

FIG. 4 indicates schematically the data flows occurring in the system to support user information, receipting and discounting processes.

### OVERVIEW

The point of sale transaction system might typically be used in a supermarket environment. An electronic shopping list is created on the system, according to user selections, either automatically for instance by a scanner mounted on a shopping trolley or more conventionally at the point of sale terminal. The user then uses a handheld device such as a mobile phone to initiate payment via the transaction system by entering a PIN. The PIN enables the system to use financial data such as a credit card number to carry out a transaction for the user. The PIN and the financial data provide first and second parts respectively of authorisation data used by the system to enable a transaction.

The mobile phone itself carries no confidential data. The PIN is entered in real time by the user and the financial data is stored on, or accessible by, the transaction system. The transaction system can also process the shopping list to obtain a cost for the transaction, if necessary, and interface with both automated stock-keeping and customer relationship management systems.

Referring to FIG. 1, important components of the transaction system are a client device called the Tagboard box 100 which sits near the point of sale terminal 105, and a server device called the Tagboard server 110 which is located elsewhere, in a secure non-public environment.

Interfaces

Mobile phone 115-Tagboard box 100: there are a number of ways to provide an interface and connection 120 between the user's mobile phone 115 and the Tagboard box 100. A good way is to use a contactless card reader conforming to the protocol ISO (International Standards Organisation) standard 14443 (various types). Processes of the Tagboard box 100 can be written to treat this in the manner of a smart card interface and can read and write to the shared memory of the mobile phone 115. The reader can be provided in a plastic rest, slightly larger than a phone and incorporating a polymeric or organic light emitting diode (PLED or OLED) for mimicking messages from the point of sale terminal 105. Messages that would be mimicked are the messages a point of sale terminal would normally send in a card transaction via a card reader of this type but are here being sent by the Tagboard box 100 to the shared memory of the mobile phone 115. A rest of this type can be incorporated into a cheque writing rest as already provided in many stores.

Tagboard box 100-point of sale terminal 105 and the Tagboard server 110: the Tagboard box 100 operates using a serial protocol and has wired connections 140, 145 to the point of sale terminal 105 and the Tagboard server 110. The connections can be for example a plug and socket, wire, fibre and/or cable connection. However, preferably, a TCP/IP converter is provided so that the Tagboard box 100 can use TCP/IP protocols in communicating with the point of sale terminal 105 and the Tagboard server 110.

Tagboard server 110: The Tagboard server 110 can communicate with the point of sale terminal 105 using TCP/IP. It also has:
one or more network connections 150 to internal and/or external finance systems 125 for making payments and supporting the transfer of cash amounts to the mobile phone 115
a network connection 155 to a mobile device checkpoint 130 for checking whether the mobile phone 115 has been reported stolen
a network connection 160 to a data store such as a hard disc 135 for in-house data processing such as the stock-keeping and customer relationship management mentioned above.

These connections are further discussed below with reference to FIG. 3.

Point of sale terminal 105: this has a standard interface and card reader and is not further discussed herein.

Prompts and Data Flow in a Transaction

In this example, a shopping list of items covered by the transaction has been compiled in a conventional manner by a point of sale terminal 105. The point of sale terminal 105 generates a prompt asking:
Pay by cash?
Pay by card?
Pay by mobile?

If either of the first two is selected, the transaction can be completed in a known manner. If “Pay by Mobile?” is selected, the point of sale terminal 105 establishes a link with the the Tagboard box 100 and sends the amount of the transaction. This triggers a message on the point of sale terminal 105: “Place phone on TBB reader”. The Tagboard box 100 can now communicate to shared memory in the telephone 115. At this point, the user has decided that payment is to be made via the Tagboard system. The Tagboard system includes a back-end transaction engine, which supports three types of payments, namely:

1) Pre-payment (discussed below under the heading “Tagboard box: e-Wallet”);

2) Card, preferably Chip and PIN (discussed below under the heading “2. Bank/Card Authorisation”); and

3) Customised.

In the “Customised” approach, the Tagboard system is designed to deal with any of several payment systems. For example, VISA have adopted a Chip & PIN approach; MasterCard have another approach as do AMEX. A Tagboard system can be customised to support all these approaches as well as non-EMV (electronic money verify) architectures, using the arrangements and processes further described below.

Once payment is to be made via the Tagboard system and the telephone 115 is on the TBB reader, the Tagboard box generates a prompt on the telephone display: “Enter PIN”. This PIN is the user's PIN, authorised for use of the Tagboard system. The following prompts and data flow now occur.

FIG. 1 shows four sets of communications along the various connections in the system which occur in making a payment transaction. The four sets of communications are as follows:
1. PIN login
2. Mobile handset validation by network provider
3. Card authorisation
4. Transaction completion

These are described in more detail below.

1. PIN Login and Validations

This function wakes up the mobile phone 115 within the shopping environment and checks the validity of the proposed transaction. As shown on FIG. 1, the following steps are performed:
1a—the user enters a PIN to the mobile phone 115 which triggers the phone to perform a handshake with the Tagboard box 100. The Tagboard box 100 then requests the phone number from the phone 115
1b—the Tagboard box 100 sends the PIN and the phone number to the Tagboard server 110
1c—the Tagboard server 110 checks that the PIN and the phone number match and that the phone number is a registered client and, if the check result is positive, sends the phone number to the network provider's system 130 (or other phone number validation means)
1d—the network provider's system 130 establishes if the phone is valid and not reported stolen and sends a validation report to the Tagboard server 110
1e—As long as the PIN and the phone number match, the phone number is a registered client and the validation report at 1d was ‘Valid’, the Tagboard server 110 notifies the Tagboard box 100 using the message “PIN OK”. (If the validation report at 1d above is ‘Invalid’, then the Tagboard box 100 simply notifies the phone 115 and there will be no transaction unless a valid PIN is subsequently given)
1f—the Tagboard box 100 then notifies the telephone 115 and the point of sale terminal 105 using the message “Transaction OK”.

At this point, the Tagboard box 100 also triggers display of the following menu at the telephone 115:
Cash from the e-Wallet in the phone*
Switch card*
Credit card
Debit Card
Store card
Internet bank account via WAP
   * with optional Cashback

If the user selects to pay using cash from the e-Wallet in the telephone 115, the payment process is relatively simple since a “cash” credit has been entered to the telephone 115 using a validated procedure (further discussed below under the heading “Tagboard box: e-Wallet”) and the e-Wallet total can simply be decreased by the amount of the transaction as long as the transaction amount is not more than the e-Wallet total. However, if the user selects a card or bank account option, the following prompts and data flow occur.

2. Bank/Card Authorisation

If the user selects an option with optional Cashback, a message is displayed: “Cashback required?” and the user is prompted to enter the amount.
2a—The amount is notified to the point of sale terminal 105 via the Tagboard box 100 and the point of sale terminal 105 is requested by the Tagboard box 100 to send the shopping list to the Tagboard box 100.
2b—the point of sale terminal 105 sends the shopping list to the Tagboard box 100
2c—the Tagboard box 100 sends the list to the Tagboard server 110 (including any additional cash sum requested as “Cashback” as part of the final total)
2d—the Tagboard server 110 logs the list onto its hard disc 135
2e—the Tagboard server 110 issues a credit check request to an internal and/or external finance system 125
   3. Transaction Completion

Once the credit check request has been processed, the Tagboard server 110 receives a notification from the finance system 125. If it is negative, the Tagboard server 110 may reissue the credit check request to different finance systems 125 in turn until a positive notification is received or there are no more finance systems 125 to query. If there are no more finance systems 125 to query, then the transaction will be terminated and a cancellation message sent to the point of sale terminal 105 and optionally the phone 115, via the Tagboard box 100. Otherwise the following steps occur:
3a—the finance system 125 sends positive notification to the Tagboard server 110
3b—the Tagboard server 110 logs the positive notification to the hard disc 135 in respect of the relevant PIN and shopping list
3c—the Tagboard server 110 then confirms ‘transaction OK’ to the Tagboard box 100
3d—the Tagboard box 100 says ‘transaction OK’ to the point of sale terminal 105 which then processes the transaction in the normal way of bank or card payment and notifies the Tagboard box 100
3e—the Tagboard box 100 says ‘transaction OK’ to the phone 115

The above describes a payment using a bank or card account. As described below under the heading “The Tagboard server 110”, the Tagboard system stores a user's account details against a Tagboard PIN so that the system can query appropriate finance systems 125 for the user. Such a system has the advantages that no physical card will be needed, since the details are stored on the Tagboard server 110 or mobile device 115 and the transaction rate via the Tagboard system can be faster. Money can thus be saved on card production. Further, it is relatively simple to design the Tagboard system so that a small charge is made to the user, for example for each transaction, and this charge can potentially be shared in a commercial arrangement for example with the retailer.

However, more organisations are moving to Chip & PIN payments for added security. The Tagboard system can equally well support Chip and PIN payments although there is a need for an additional prompt for the user to enter the PIN via the Handset 115. Otherwise, the transaction appears as a normal Chip & PIN transaction.

If the user selects an Internet bank account, the process is slightly different in that, instead of Step 2e above, the user accesses their account Website directly from the telephone 115, using a Wireless Applications Protocol link. Once the user has accessed their account successfully, it is necessary to transfer funds from their Internet account to a target account held by the store or supermarket. Details of the target account could be entered manually to the telephone 115 for transfer to the account Website but it is preferably done automatically via the Tagboard box 100. This can be achieved by a new Step 3a in which a positive notification can be notified to the Tagboard box 100, and thus to the Tagboard server 110, from the shared memory in the telephone 115, followed by Steps 3b and 3c as above. Step 3d is modified in that the Tagboard box 100 now says “transaction OK” to the telephone and delivers the target account details to the telephone for onward delivery to the user's account Website—Step 3e. Once the user's account has been debited and the telephone 115 receives confirmation from the account Website, this is passed to the Tagboard box 100.

In the arrangement for debiting an Internet account described above, there is no advance confirmation that the transaction will go through successfully, as there is with the conventional bank/card arrangements described earlier. If the transaction fails, the telephone 115 will receive a failure message from the account Website. In this circumstance, Step 3b needs to be reversed. On receipt of a failure message, the telephone 115 notifies the Tagboard box 100 which in turn notifies the Tagboard server 110. The Tagboard server 110 cancels the positive notification to the hard disc 135 previously sent in Step 3b.

The Tagboard Box 100

Referring to FIG. 2, each point of sale terminal 105 has a Tagboard box 100 connected to it. The Tagboard box 100 controls all interactions between the mobile device 115, the point of sale terminal 105 and the Tagboard server 110.

Tagboard Box: e-Wallet

An interesting aspect of the transaction system is the e-Wallet pre-payment system in which the user can purchase a cash amount, for instance £50, from a retailer. This amount is set up on the Tagboard Server 110 and decremented as the user uses the balance via the mobile device 115. (Alternatively, the e-Wallet functionality can be provided at the mobile device 115.)

A money amount can be authorised and credited to an e-Wallet total at any time but it might also be requested as a “Cashback” service by the user at the time of making a purchase at the point of sale terminal 105. An operator enters the request to the point of sale terminal in a conventional manner and it is added to the shopping list compiled in known manner by the point of sale terminal 105. It will thus be funded by the customer in the same way as the rest of the shopping list, via the Tagboard server 110.

The Tagboard system can be designed to earn a small margin on each decrement of the e-Wallet amount.

Cashback might be delivered physically to the customer from the point of sale terminal 105. However, the e-Wallet process 200 provided by the Tagboard box 100 enables cash to be delivered to the mobile device 115 electronically. This has the advantage that the point of sale terminal can carry less, or even in some circumstances zero, cash and thus improve security. The e-Wallet process 200 could for instance be triggered by a Cashback code in the shopping list received by the Tagboard box 100 from the point of sale terminal 105, or by a specific Cashback alert issued by the point of sale terminal 105.

Where the e-Wallet process is provided on the mobile device 115, it is necessary that the mobile device 115 has means for recording a cash amount in response to an authorised transaction and for subsequently debiting it in response to one or more further transactions. This might be provided for example by the use of a card in the mobile device 115 which can be written to by the e-Wallet process 200 in the Tagboard box 100, for example a flash memory card or the known “Universal Subscriber Identity Module” (USIM). The further transactions in these circumstances have the major advantage that they can be unauthorised and therefore potentially very quick since the cash has been funded by the user in the initial transaction. The e-Wallet process 200 in general therefore is adapted to respond to an authorised transaction by increasing the recorded cash amount on the card and to respond to an unauthorised transaction by decreasing the recorded cash amount.

(It will be understood that the above e-Wallet process only applies for use with embodiments of the present invention and is not a universal mechanism such as the Mondex system.)

In supporting unauthorised transactions, the processes for “2. Bank/Card Authorisation” and “3. Transaction Completion” described above can be considerably reduced since there is no longer a need to refer to an internal and/or external finance system and the Tagboard server 110 is only used for record keeping. Thus Step 2e, the credit check request by the Tagboard server 110 to an internal and/or external finance system, can be deleted. In “3. Transaction Completion”, Steps 3a to 3c are also deleted, being replaced by a step in which the e-Wallet process 200 in the Tagboard box 100 attempts to delete the shopping list cost total from the card in the mobile device 115. If the total is insufficient, this fails and the e-Wallet process 200 notifies the point of sale terminal 105, the Tagboard server 110 and the mobile device 115.

The Tagboard Server 110

Referring to FIG. 3, the connections and processes of the Tagboard server 110 are shown in more detail than in FIG. 1. In practice, the connections 150, 155 (shown in FIG. 1) to external finance systems 125 and to the mobile device checkpoint 130 are provided over a link 320 (shown in FIG. 3) to a public network such as the Internet or a telephone network. The Tagboard server 110 is also connected locally, for instance via a Local Area Network (LAN) 315, to other internal elements of the transaction system, such as the hard disc 135 and software and data supporting a store card 325 and an intermediary banking system 330. The LAN 315 might also provide the connections 145, 140 to the Tagboard boxes 100 and the point of sale terminals 105 and support TCP/IP protocols.

It should be noted that the location of the various processes run by the Tagboard server 110 may be on the server 110 or elsewhere. In FIG. 3, some processes such as the user information process 345 are shown on the server 110 and some processes such as the receipt generator 350 are shown separately from the server 110, connected to it over the LAN 315. This distribution and network arrangement is not important however and is likely to depend in practice on local (or even remote) availability of processing capacity.

In known manner, the Tagboard server 110 might itself be provided with a client device (not shown) for requesting data or services from an internal or external server device (not shown). This may be the arrangement for example where internal or external finance systems can be accessed by the Tagboard server 110, in a further client/server arrangement, to fulfil a request from the Tagboard box 100.

The Tagboard server 110 maintains data on the hard disc 135 enabling it to connect to various external financial systems to make credit checks and to debit funds in making a transaction. For instance, it will carry the telephone numbers of credit card systems such as VISA and Mastercard and the Web addresses of Internet banking systems. It will also carry the number or address of one or more services 130 for validating the phone numbers of mobile devices 115 (not shown in FIG. 3) initiating a transaction. An authorisation/validation process 355 is provided for making the various checks, maintaining and updating data on the hard disc and interacting with external systems as necessary.

The Tagboard server 110, using the authorisation/validation process 355, manages the second part of the authorisation data necessary for a user to make a payment transaction. That is, it stores one or more PINs for each registered user of the system, and provides a mapping capability for mapping PINs to financial data such as credit and store card numbers. Preferably, it also stores at least one email or SMS (Short Message Service) address for each user for use in receipt delivery and marketing alerts, further mentioned below. This data is stored on the hard disc 135 in a user data store or user information store, maintained by a user data maintenance process 345 further discussed below.

Instead of one or more PINs for each user, the Tagboard server 110 may store the user's mobile device telephone number mapped to the financial and contact data. However, this reduces flexibility since the use of multiple PINs allows each user to register more than one financial or contact “profile” with the transaction system. For example, a business user might wish to use a business account for transactions in an IT (Information Technology) department of a store and a personal account for transactions in the food department of the store. The use of multiple PINs also allows more than one user to use a shared mobile device 115 to access their own respective financial and contact data.

It is also possible for the PIN to be validated by the mobile device rather than transmitting the PIN to the server 110, thus reducing a security risk associated with transmitting the PIN. In order to maintain flexibility, the mobile device 115 could then transmit not the PIN itself but a validation signal randomly assigned to the PIN. For example, where the PIN is “1234”, the mobile device 115 could transmit “Vfgh”, which notifies the server 110 that the PIN has been validated and also delivers a PIN-specific code which can still be mapped to the financial and contact data.

An important feature of the user “profile”, whether mapped to a PIN or a telephone number or both, is that the user can list sources of funds in a preferred order. This allows the Tagboard server 110 to scan through the list until a sufficient balance is found to complete a payment.

Tagboard Server 110: List Processor 300

The Tagboard server 110 is also provided with a software process, which is the list processor 300. As described above, during a transaction the point of sale terminal 105 compiles a shopping list which is then sent to the Tagboard server 110 via the Tagboard box 100. The compiled list may already be priced as received from the point of sale terminal 105. However, a powerful aspect of list processing by the Tagboard server 110 is that the list processor 300 may have access, in use, to current pricing and/or discounting data to enable it to recalculate a cost total for use in a transaction. The pricing and/or discounting data might be applicable across all transactions. Alternatively, it might be user-specific. Because the Tagboard server 110 manages user records in a user data store on the hard disc 135, it can also apply user-specific discounts. Thus if the relevant user has a store card, or is entitled to other forms of discount such as a loyalty discount, this can be flagged in the user data store against one or more identifiers for the user. The list processor 300 refers to the user data store to check if there is a relevant flag. If so, it refers to the current pricing and/or discounting data to enable the Tagboard server 110 to apply suitable prices or discounts prior to closing a transaction.

Additionally, again because the Tagboard server 110 manages user records in a user data store on the hard disc 135, it is able to provide transaction receipts which are customised for the user and/or a particular service being provided. These can be transmitted to the user separately from the immediate transaction, for instance by email, and are further discussed below.

The list processor 300 is also preferably connected to a stock-keeping system (not shown) to support automated updates. Stock-keeping systems are generally known and therefore not further described herein.

Tagboard Server 110: Current Pricing and Discounting System 335

To enable a current pricing and discounting system as described, there may be a current pricing and discounting software process 335 connected to the LAN 315 which carries rules or algorithms for calculating such things as loyalty discounts. This process 335 may interact with user profiles stored in the user data store on the hard disc 135 to maintain a user-specific discounting facility. To enable this, the processes for “2. Bank/Card Authorisation” and “3. Transaction Completion” described above need to be expanded as follows. After 2d (Tagboard server 110 logs the shopping list onto its hard disc 135), there will be an additional step in which the Tagboard server 110 accesses a user profile on the hard disc 135 to check whether there are relevant user discounts. If not, no further action is required. However, if there are relevant user discounts, the Tagboard server 110 amends the pricing applied to the shopping list, logs the amendments, and only then issues a credit check to a finance system 125. If a positive notification is received, the existing steps of “3. Transaction Completion” are carried out, but now including using the current pricing and discounting system 335 to review the updated transaction records for the user profile to see if a requirement has been met for a further discount or a change to an existing discount. If such a requirement has been met, the user profile is now updated accordingly so that the next transaction will be subject to appropriate discounts.

A process to support discounting in use is further described under the heading “6. List processing to apply discounting” below.

Tagboard Server 110: Alerts and Transaction Receipts

The Tagboard server 110 is provided with an email and/or SMS capability 310. This enables it to contact registered users by email or text messaging. The email facility can be used in conjunction with a user information application 345 (also referred to herein as the user data maintenance process 345) to send transaction receipts to the user, rather than or as well as issuing paper receipts at the point of sale, and/or to communicate with the user more generally, for instance to alert the user to suitable special offers (selected for instance by reference to the user profile in the user data store on the hard disc 135). In a service of this sort, the transaction receipts are preferably presented in “plain English” and can be customised for example by preferred grouping of goods on the receipt or the presence or absence of tax information.

A process to support user-specific receipting in use is further described under the heading “5. Transaction Receipts” below.

This notification capability can potentially be extended by use of known tools such as Wayfinder, available from Wayfinder Systems AB, which works by connecting over the Internet to a server which plans and returns the routing instructions. This map server also has access to digital mapping and can send maps to the mobile phone allowing your current position to be plotted on the phone's screen. This uses a global positioning system and is capable of giving navigational aids within a current cell where the mobile device 115 is active. Global positioning is sufficiently accurate that this can be done in real time, while the user is in store, so that they can be directed to special offers within the store. The system can also answer user queries, which is useful in large stores if the user needs direction to particular goods.

Navigational aids and special offers can be delivered to the mobile device 115 using the short range wireless connection 120. The user would usually have their mobile device connected to the public network and thus SMS or email could be used but, if security were an issue, delivery could be made using a local function and/or a private network operating solely in the local environment.

Tagboard Server 110: Intermediary Banking System 330

An intermediary banking system 330 is mentioned above. An intermediary banking licensee is a person or organisation licensed by the Central Bank of a designated country, for example the Bank of England in the UK, to accept, keep in deposit, or help invest or transfer assets belonging to third parties. Such a licence is known for instance as a “Deposit Taking Licence”.

In the context of the present invention, the intermediary banking system 330 is a system provided by an intermediary banking licensee to give access to existing banking facilities for non-banking third parties to use in marketing their own brand. The system 330 provides a “Back-Office”, which is run by the intermediary licensee and a “Front-Office”, which is run by the brand owner. The Back-Office therefore has a connection 340 to the public network 305 for communication with banking providers and the Front-Office is connected to the LAN 315 for interaction with users via the Tagboard box 100. The intermediary system 330 can be designed to provide services such as own branded cards, bank statement automation such as itemised transactions, server farms and call centres.

User-Specific Data

Reference is made above in several instances to user-specific data, or user profiles, held on the hard disc 135 and maintained for instance by the user information process 345 and/or the shopping list processor 300 on the Tagboard server 110. The type of user-specific data held and maintained can of course be modified but to support the various arrangements described above, the user-specific data would comprise at least the following:
PINs or telephone numbers mapped to financial data for use in authorisation of transactions
Ordered list of funds such as credit and bank accounts for use in authorising transactions, possibly sorted according to type of goods
Email or SMS addresses for receiving transaction receipts and special offers
Membership of loyalty or other card schemes, and/or subscriptions to services
Transaction records for use in calculating user-specific discounts such as loyalty discounts
Receipt customisation such as layout and grouping of goods listed
Interests in special offers on particular goods

In any process involving the user-specific data held on the hard disc 135, it will usually be the user information application 345 which accesses or updates the data. Therefore in the “3. Transaction Completion” process described above, it is the user information application 345 which carries out steps 3b and 3c, logging a positive notification to the hard disc 135 in respect of the relevant PIN and shopping list and confirming “OK” to the Tagboard box 100.

Referring to FIG. 4, there are two further sets of communications which occur and which particularly involve the user-specific data held on the hard disc 135. These occur in support of action by the user information application 345 to send transaction receipts to the user and in support of action by the list processor 300 to apply current pricing and/or discounting data and are further described below:

5. Transaction Receipts

If the user has subscribed to the appropriate service for transaction receipts to be sent to a specified network address, the user information application 345 will have recorded the fact against the user's PIN on the hard disc 135 and will also have recorded the specified address. The following steps will occur to support such a service, after “3. Transaction Completion” has occurred as described above, as shown in FIG. 4:
4a—the user information application 345 checks for a specified address for receipt delivery against the PIN received for the transaction
4b—the user information application 345 checks for a receipt layout preference against the PIN received for the transaction
4c—if either an address or a layout preference is stored against the PIN, the user information application 345 initiates receipt generation by the receipt generator 350, including delivery of the logged shopping list since this contains data for use as receipt content
4d—a generated receipt is sent to the specified address, if present, or to the point of sale terminal 105 via the Tagboard box 100 where it can be printed for the user.

It should be noted that a receipting system as described above can be used independently of other aspects of the present invention and that an embodiment of the present invention might therefore comprise the receipting system.

A receipt generator 350 suitable for use in the receipting system could be designed relatively simply, having for instance a set of available layouts and sorting criteria selectable by the user via a form input or the like. Available layouts may include/exclude a tax component such as value added tax in the UK and may offer subtotals for goods and services in user-selectable categories.

6. List Processing to Apply Discounting

The following steps will occur to support discounting, after step 2d in which the Tagboard server 110 (represented by the user information application 345) logs the list onto its hard disc 135 as described above, as shown in FIG. 4:
5a—the list processor 300 checks with the current pricing and discounting system 335 for the presence of current pricing and discounting rules which relate to the transaction
5b—the list processor 300 triggers the user information application 345 to check for user-specific discounts indicated against the PIN received for the transaction
5c—if either check returns a positive result, the list processor 300 processes the list to apply the rules or discount and recalculates a cost total
5d—the list processor 300 logs the processed list onto the hard disc 135 as a transaction record against the PIN for the current transaction and returns the processed list to the tagboard box 100 for notification to the point of sale terminal 105
5e—the list processor 300 alerts the user information process 345
5f—the user information process 345 reviews the transaction records logged against the PIN for the current transaction, using a discounting rule or algorithm for a service the PIN is registered against, and up-dates the user-specific discounts indicated against the PIN if the latest transaction triggers a change, for instance because a threshold quantity has been passed.

It should be noted that a payment system having a list processor as described above can be used independently of other aspects of the present invention and that an embodiment of the present invention might therefore comprise such a payment system.

The current pricing and discounting system 335 is not necessarily provided in the Tagboard server 110 environment but may already be present as part of a pricing system supporting the point of sale terminals 105. If that's the case, then step 5a may not be necessary since the shopping list delivered to the Tagboard server 110 may already reflect current pricing and discounting.

Security

Referring to FIGS. 1 and 3, in general, security is provided in embodiments of the present invention by avoiding the storage of authorisation data on the mobile device 115. Additionally, communication between the mobile device 115 and the system, via the Tagboard box 100, is done using a short-range connection such as infrared. It is however possible to add capabilities in both areas, such as the use of encryption, fuller use of the USIM on the mobile device 115 and support for Bluetooth and long range infrared communication.

For added security, reporting messages such as email or SMS, can be sent to a different device from the mobile device 115 used at the time of a transaction. This can be implemented via the user profiles stored on the hard disc by the Tagboard server 110.

The Tagboard server 110 itself, and processes and data associated with it such as the current pricing and discount system 335, carry confidential information and are therefore preferably located in a secure location. Both the Tagboard server 110 and the Intermediary banking system 330 have a link 320, 340 to at least one public network 305, such as the Internet and/or a telecommunications network, and they are therefore protected by a firewall and equipped to encrypt data.

Additional Aspects of Implementation

Embodiments of the present invention can be used with a variety of mobile devices 115 relying generally on mobile wireless telemetry. For example, the mobile device 115 might be embodied as a mobile phone, a personal digital assistant or the like. It only requires a communication capability such as a short-range infrared port to communicate with the Tagboard box 100 and the means for a user to input the first part of the authorisation data, such as a PIN. Preferably however, the mobile device 115 also has memory of some sort, suitable for supporting the e-Wallet facility. Where the device 115 is a mobile phone, it might be third generation enabled, such as UMTS (Universal Mobile Telecommunications System), or any later technology to be developed, and it might communicate with a public network by any available means such as Mobitex or satellite. (Mobitex is an International Standard 12.5 kHz narrow band radio technology, which is data only.)

Although any suitable form of software can be used, an embodiment of the invention can be based on a Java based (J2EE/J2ME) architecture, and might also benefit from use of a known “M-Commerce” payments system and an EMV architecture for encryption. M-Commerce payments systems are known and not further described herein. Europay, MasterCard and Visa collaborated in early 1996 to produce the EMV specifications that define an international, open encryption standard to allow safe, easy electronic commerce. The specifications are publicly available. EMV may be used in embodiments of the present invention where encryption is beneficial. EMV is not further described herein.

Java is a known software language and environment developed by Sun Microsystems Inc. The “Java 2” Platform provides robust end-to-end solutions for networked applications as well as a trusted standard for embedded applications. It includes three editions: the Enterprise edition J2EE, the Standard edition J2SE and the Micro edition J2ME. The high-level architecture of a Java wireless enterprise application, applicable to embodiments of the present invention, is similar to that of a canonical J2EE application. However, Java tends to use relatively high memory capacities.

Aternative languages that might be used in embodiments of the invention include object-oriented languages such as “C#” by Microsoft. This provides the computing power of the C++ language and the ease of use of Microsoft's Visual Basic language.

Potential Uses of Embodiments of the Invention

Embodiments of the invention can be used wherever there is purchase of goods or services and thus might be used in the following scenarios:
Supermarket shopping
Duty free shopping
Automated car parking
ATM cash withdrawal
3^{rd} Party payments
Electronic Metering
24 hour convenience retailing
Kiosk banking
Payment for sundry items, vending machines
Secure safekeeping of hard currency
Foreign Exchange
Congestion Charging
Airline, Train, Ferry ticket dispensing

It will be noted that as well as cash tills in supermarkets, the point of sale terminal 105 in embodiments of the invention may also be embodied as an ATM, a vending machine, or indeed any of a range of equipment for dispensing goods or services.

The functionality of embodiments of the invention generally covers the following aspects:
Payments interfacing to credit, debit, switch, intermediary or other financial systems
Provision of cash equivalent for unauthorised transactions
Mobile phone interface with the PoS, Till, ATM or Dispenser
Server transactions
Receipt processing and customised delivery
Shopping list processing
Information service

Embodiments of the present invention have several benefits such as providing systems which support and develop brand loyalty while simplifying the overall shopping process and improving security for the user and vendor.

It should be noted that, for the purposes of the present specification, the word “comprising” is intended to be interpreted, unless the context indicates otherwise, so as to include for instance at least the meaning of either of the following phrases: “consisting solely of” and “including amongst other things”.

It will be understood that embodiments of the present invention may be supported by platform of various types and configurations. The presence of the platform is not essential to an embodiment of the invention. An embodiment of the present invention might therefore comprise software recorded onto one or more data carriers, or embodied as a signal, for loading onto suitable platform for use.

1. Payment apparatus for use in authorised transactions, the apparatus comprising:
i) at least one client device provided with an input for communicating with one or more mobile devices; and
ii) at least one server device for providing data and/or processes to support a transaction using the at least one client device, said transaction including verification of authorisation data;
wherein the at least one client device is adapted to receive a first part of the authorisation data via its input and the apparatus is adapted to store a second part of the authorisation data, and
wherein the at least one server device is provided with a user data store adapted to store one or more sets of user-specific data for use in authorising transactions, and a user data maintenance process for storing and updating user data in the user data store.

2. Payment apparatus according to claim 1 wherein at least one set of user-specific data is stored in association with a said first part of the authorisation data.

3. Payment apparatus according to claim 1, further comprising a list processor for processing a list of items covered by a transaction.

4. Payment apparatus according to claim 3 wherein the list processor is adapted to access user-specific data for use in processing a list in the course of a transaction.

5. Payment apparatus according to claim 4 wherein the list processor is adapted to use said user-specific data to apply a discount in relation to said transaction.

6. Payment apparatus according to claim 1 wherein the apparatus is further provided with a connection, in use, to a public network.

7. Payment apparatus according to claim 1 wherein the apparatus is further provided with a receipt generator for generating transaction receipts, and the receipt generator is adapted to refer to user-specific data in generating a transaction receipt.

8. Payment apparatus according to claim 7 wherein the user-specific data includes a public network address for at least one user and the receipt generator is adapted to transmit a transaction receipt to said public network address.

9. Payment apparatus according to claim 1 wherein each set of user-specific data is stored in association with a respective user identifier.

10. Payment apparatus according to claim 9 wherein more than one user identifier may be stored in relation to at least one user, a different set of user-specific data being stored in association with each user identifier related to that user.

11. Payment apparatus according to claim 1 wherein, in use, at least one set of user-specific data comprises an ordered list of funds.

12. Payment apparatus according to claim 11 wherein said ordered list is sorted according to type of goods.

13. Payment apparatus according to claim 11 wherein the at least one server device is provided with a scanning process for scanning through the ordered list until a sufficient balance is found to complete a transaction.

14. Payment apparatus for use in authorised transactions, the apparatus comprising:
i) at least one client device provided with an input for communicating with one or more mobile devices; and
ii) at least one server device for providing data and/or processes to support a transaction using the at least one client device, said transaction including verification of authorisation data;
wherein the at least one client device is adapted to receive a first part of the authorisation data via its input and the apparatus is adapted to store a second part of the authorisation data, the first part of the authorisation data comprising one of a personal identification number and a code specific to a personal identification number.

15. Payment apparatus according to claim 14 wherein the second part of the authorisation data comprises financial data.

16. Payment apparatus according to claim 14 wherein each client device is connected to a point of sale terminal.

17. Payment apparatus according to claim 14 wherein the at least one server device is provided on a networked computing platform in a secure location.

18. Payment apparatus according to claim 17 wherein the second part of the authorisation data is stored by the at least one server device, or can be accessed by it, in fulfilling a service request from the client device(s).

19. Payment apparatus according to claim 14 wherein the apparatus is further provided with a mapping capability for mapping the first part of the authorisation data to the second part.

20. Payment apparatus according to claim 19 wherein the mapping capability is provided by the at least one server device.

21. Payment apparatus according to claim 14 wherein the at least one server device is provided with at least one further client device so that it can initiate a service request to another server device.

22. Payment apparatus according to claim 14 wherein each input for communicating with one or more mobile devices supports a wireless connection.

23. Payment apparatus according to claim 22 wherein the wireless connection has a range of 0.5 meters or less.

24. Payment apparatus according to claim 22 wherein the wireless connection comprises an infrared connection.

25. Payment apparatus according to claim 14, further comprising validation means for validating a unique identifier for each mobile device.

26. Payment apparatus for use in authorised transactions, the apparatus comprising:
i) at least one client device provided with an input for communicating with one or more mobile devices;
ii) at least one server device for providing data and/or processes to support a transaction using the at least one client device, said transaction comprising a transfer of funds between financial accounts and including verification of authorisation data; and
iii) update means for updating data representing a cash amount, wherein the at least one client device is adapted to receive a first part of the authorisation data via its input, the apparatus is adapted to store a second part of the authorisation data, and the apparatus is adapted to support a transaction comprising a transfer of funds at least in part by updating the data representing a cash amount.

27. Payment apparatus according to claim 26 wherein said data representing a cash amount is held, in use, on the one or more mobile devices.

28. Payment apparatus according to claim 26 wherein said data representing a cash amount is held, in use, on the at least one server device.

29. Payment apparatus according to claim 26 wherein the payment apparatus is adapted to support one or more unauthorised transactions, the update means being adapted to respond to a transaction including verification of authorisation data by increasing the cash amount and to respond to an unauthorised transaction by decreasing the cash amount.

30. Payment apparatus according to claim 26 wherein the at least one server device is provided with a user data store adapted to store one or more sets of user-specific data for use in authorising transactions, and a user data maintenance process for storing and updating user data in the user data store.

31. A receipting system for use in a purchasing transaction, the system comprising:
i) an input for receiving transaction information;
ii) a receipt generator for generating a receipt for a notified payment;
iii) a data store for storing network addresses; and
iv) an interface to a network for transmitting a generated receipt to a network address,
wherein each transaction has an associated identifier and the data store stores network addresses in association with transaction identifiers such that each generated receipt can be transmitted to a network address associated with the transaction giving rise to the generated receipt.

32. A receipting system according to claim 31 wherein at least one identifier associated with a transaction comprises or represents a personal identification number.

33. A receipting system according to claim 31 wherein the data store is adapted to store one or more sets of user-specific data for use in authorising transactions, and a user data maintenance process for storing and updating user data in the user data store, said network addresses being stored as user-specific data.

34. A payment system for use in user transactions, each transaction giving rise to a price list for goods or services covered by the transaction, wherein each user has at least one associated identifier, the payment system comprising:
i) a data store for storing user specific data in association with at least one of said identifiers; and
ii) a price list processor for processing a price list arising from a transaction, wherein the system further comprises an input for receiving identifiers and the price list processor is adapted to process a price list arising from a transaction by applying user specific data from the data store, the user specific data being associated with an identifier received in relation to said transaction.

35. A payment system according to claim 34 wherein at least one user has at least two associated identifiers and the data store, in use, stores different user specific data in association with each respective identifier associated with said at least one user.

36. A method of authorising a transaction, which method comprises the steps of:
i) receiving an identifier;
ii) using the identifier to locate a set of one or more authorisation codes for payment systems;
iii) receiving transaction information; and
iv) authorising the transaction information with a payment system by use of an authorisation code from said set.

37. A method of providing a receipt in respect of a transaction, which method comprises the steps of:
i) receiving transaction information from a communication device having an address in a public network;
ii) making a transaction in respect of goods or services;
iii) generating a receipt in respect of the transaction;
iv) transmitting the generated receipt to a communication device having a different address in a public network.
